(19) United States
(12) Patent Application Publication
(10) Pub. No.: US 2001/0025342 A1
(43) Pub. Date: Sep. 27, 2001

(54) Biometric identification method and system

(76) Inventor: Kaoru Uchida, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/775,617

(22) Filed: Feb. 5, 2001

(30) Foreign Application Priority Data
Feb. 3, 2000 (JP) 025816/2000

(51) Int. Cl. H04L 9/00; H04L 9/32

(52) U.S. Cl. 713/186; 380/44

(57) ABSTRACT

A biometric identification system ensuring reliable and protective identification of individuals even in a system having a biometric input device and a biometric verifier are separately provided is disclosed. The biometric data input device has a biometric data sensor and an encoder that encodes digital biometric data using secret information identifying the biometric data input device to transmit encoded data to the biometric verifier. The biometric verifier decodes the encoded data using the secret information to reproduce digital biometric data. The identity of the individual is verified when the digital biometric data is a registered biometric feature of an authorized user and the biometric data input device is an authorized device.

### BACKGROUND OF THE INVENTION

1. Field of the Invention

The present invention relates to a method and system for identifying individuals using biometric data representing a certain physical characteristic of an individual, and in particular to a biometric identification method and system suitable for a system in which a biometric data input device and a biometric data comparison device are separately provided.

2. Description of the Related Art

In network-based information services, identification of individuals is one of the most important issues to ensure protection of communications security against abuse, unauthorized use, tempering by unauthorized persons, pretending to an authorized person, or the like. The identification must be accurate but not too cumbersome. To meet such a condition, there have been proposed a number of biometric identification techniques. Biometric data is data representing a certain human characteristic that is not changed over all one's life and is different from person to person, typically fingerprints, hand geometry, retinal scans, facial images and the like.

Taking fingerprint identification as an example, a user places his/her predetermined finger on a prism so as to display its fingerprint to a scanner or a fingerprint input device. The input fingerprint image data is sent to a fingerprint verifier, in which feature data is extracted from the input fingerprint image data and then it is compared against previously stored fingerprint feature data. Since a fingerprint is a unique and distinctive pattern that presents unambiguous evidence of a specific person, accurate and simple identification of individuals can be achieved. Conventional fingerprint identification systems like this have been disclosed in Japanese Patent Application Unexamined Publication No. 4-33065 and Japanese Patent Application Examined Publication No. 63-13226.

As another prior art, there has been proposed a fingerprint verification system using encryption in Japanese Patent Application Unexamined Publication No. 5-290149. In this conventional system, fingerprint image data is inputted through a fingerprint input device and is output to a fingerprint verifier. In the fingerprint verifier, feature data is extracted from the input fingerprint image data and then the fingerprint feature data is encrypted. The encrypted fingerprint feature data is compared against encrypted feature data that are previously registered in memory to identify individuals.

However, the input fingerprint image data is transmitted as it is from the fingerprint input device to the fingerprint verifier. Therefore, if an unauthorized person steals the fingerprint image data of an authorized person and changes the cable to another cable, then security attach by the unauthorized person may occur by transmitting the stolen fingerprint image data to the fingerprint verifier. In the case where the fingerprint input device and the fingerprint verifier are separately located and connected by a network, the possibility of the security attach may be increased.

### SUMMARY OF THE INVENTION

An object of the present invention is to provide a biometric identification method and system ensuring reliable and protective identification of individuals even in a system having a biometric input device and a biometric verifier are separately provided.

According to the present invention, a system includes: a biometric data input device; and a biometric verifier connected to the biometric data input device. The biometric data input device includes: a biometric data sensor for inputting as biometric data a physical characteristic of an individual to produce digital biometric data; and an encoder for encoding the digital biometric data using secret information to transmit encoded data to the biometric verifier. The biometric verifier includes: a decoder for decoding the encoded data using the secret information to reproduce digital biometric data; and a verifier for verifying identity of the individual based on the digital biometric data.

The secret information is a unique key identifying the biometric data input device. The verifier includes: a feature extractor for extracting a feature of the digital biometric data decoded by the decoder; a first determiner for determining whether the feature of the digital biometric data is a registered biometric feature of an authorized user, by comparing the feature of the digital biometric data against previously registered biometric features; a second determiner for determining whether the biometric data input device is an authorized device, based on the secret information; and a third determiner for determining that the individual is an authorized user when the feature of the digital biometric data is a registered biometric feature of an authorized user and the biometric data input device is an authorized device.

As described above, since biometric data is encrypted or watermarked using a key assigned uniquely to the biometric data input device, the biometric verifier can determine whether the biometric data input device is an authorized machine. Accordingly, it is possible to detect a change or replacement of a biometric data input device or tampering with an output signal of the biometric data input device. Even in the case where the biometric data input device and the biometric verifier are separately provided, reliable identification of an individual can be achieved without security holes.

According to an embodiment of the present invention, a system includes: at least one biometric data input device; and a biometric verifier connected to the at least one biometric data input device. Each of the at least one biometric data input device includes: a biometric data sensor for inputting as biometric data a physical characteristic of an individual to produce digital biometric data; and an encryptor for encrypting the digital biometric data using an encryption key to transmit encrypted data to the biometric verifier, wherein the encryption key identifies the biometric data input device. The biometric verifier includes: a table storing an encryption key corresponding to each of said at least one biometric data input device; a decryptor for decrypting the encrypted data using the encryption key corresponding to the biometric data input device to reproduce digital biometric data; a comparator for comparing a feature of the digital biometric data against previously registered biometric features to produce a comparison result; and a determiner for determining whether the individual is an authorized person, based on the comparison result and correctness of the digital biometric data decrypted by the decryptor.

The determiner may determine the correctness of the digital biometric data decrypted by the decryptor depending on whether a type of the digital biometric data decrypted by the decryptor matches that of the digital biometric data outputted by the biometric data input device.

According to another embodiment of the present invention, a system includes: at least one biometric data input device; and a biometric verifier connected to the at least one biometric data input device. Each of the at least one biometric data input device includes: a biometric data sensor for inputting as biometric data a physical characteristic of an individual to produce digital biometric data; a watermark encoder for embedding secret information as a watermark in the digital biometric data to produce watermarked biometric data; an encryptor for encrypting the watermarked biometric data to produce encrypted data; and a transmitter for transmitting the encrypted data and a device identification identifying the biometric data input device to the biometric verifier. The biometric verifier includes: a table storing secret information corresponding to a device identification for each of said at least one biometric data input device; a decryptor for decrypting the encrypted data to produce watermarked digital biometric data; a watermark decoder for separating digital biometric data and watermark data from the watermarked digital biometric data decrypted by the decryptor; a first comparator for comparing a feature of the digital biometric data against previously registered biometric features to produce a feature comparison result; a second comparator for comparing the watermark data separated by the watermark decoder with secret information corresponding to the device identification identifying the biometric data input device to produce a secret information comparison result; and a determiner for determining whether the individual is an authorized person, based on the feature comparison result and the secret information comparison result.

According to still another embodiment of the present invention, a system includes: at least one biometric data input device; and a biometric verifier connected to the at least one biometric data input device. Each of the at least one biometric data input device includes: a biometric data sensor for inputting as biometric data a physical characteristic of an individual to produce digital biometric data; a watermark encoder for embedding secret information as a watermark in the digital biometric data to produce watermarked biometric data; a first encryptor for encrypting the watermarked biometric data to produce encrypted biometric data; a second encryptor for encrypting the secret information using a public key of asymmetric encryption scheme to produce encrypted secret information; and a transmitter for transmitting the encrypted biometric data and the encrypted secret information. The biometric verifier includes: a first decryptor for decrypting the encrypted biometric data to produce watermarked digital biometric data; a second decryptor for decrypting the encrypted secret information to produce received secret information; a watermark decoder for separating digital biometric data and watermark data from the watermarked digital biometric data decrypted by the decryptor; a first comparator for comparing a feature of the digital biometric data against previously registered biometric features to produce a feature comparison result; a second comparator for comparing the watermark data separated by the watermark decoder with the received secret information to produce a secret information comparison result; and a determiner for determining whether the individual is an authorized person, based on the feature comparison result and the secret information comparison result.

The biometric verifier may be connected to the at least one biometric data input device via a network. The encrypted biometric data and the encrypted secret information may be transmitted to the biometric verifier through different channels.

### BRIEF DESCRIPTION OF THE DRAWINGS

FIG. 1 is a block diagram showing the configuration of a biometric identification system according to a first embodiment of the present invention;

FIG. 2 is a block diagram showing the configuration of a biometric identification system according to a second embodiment of the present invention; and

FIG. 3 is a block diagram showing the configuration of a biometric identification system according to a third embodiment of the present invention.

### DESCRIPTION OF THE PREFERRED EMBODIMENTS

Taking as an example the case where a user logs in to a computer such as personal computer or a service system with fingerprint, preferred embodiments of the present invention will be described hereafter.

### FIRST EMBODIMENT

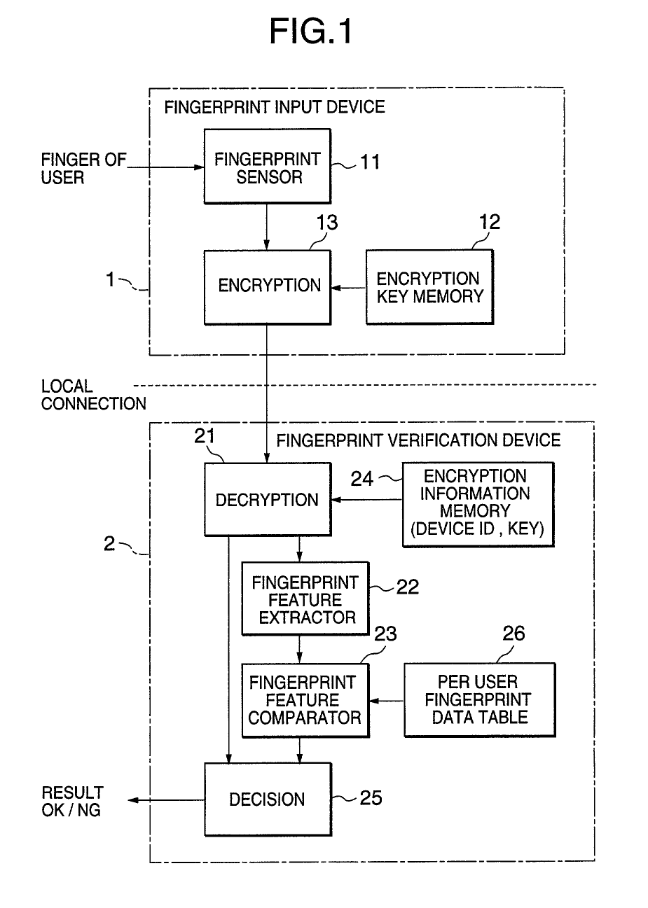

Referring to FIG. 1, a biometric identification system according to the first embodiment includes a fingerprint input device 1 and a fingerprint verification device 2, which are connected by a local connection such as a cable. A plurality of fingerprint input devices may be connected to the fingerprint verification device 2. Here, the fingerprint verification device 2 is implemented via software in a personal computer.

The fingerprint input device 1 is provided with a fingerprint sensor 11 that scans the fingerprint of a user's finger placed on a scan window to output digital fingerprint image data to an image data encryption section 13. The image data encryption section 13 encrypts the digital fingerprint image data using an encryption key received from an encryption key memory 12. The encryption key is a unique key that identifies the fingerprint input device 1 and is stored as secret information in the encryption key memory 12. For example, the encryption key is a bit string of 256 bits.

The image data encryption section 13 performs encryption of the digital fingerprint image data according to a predetermined encryption scheme to transmit the encrypted data to the fingerprint verification device 2 through the local connection. A common key system such as DES (Data Encryption Standard) system may be used. Alternatively, a public key encryption system (asymmetric system) such as RSA system can be also used. In the case of public key encryption system, the secret key held in the fingerprint input device 1 is used for encryption.

It is possible to use a scrambling method in place of the complicated encryption. The scrambling of digital fingerprint image data is performed by, for example shifting or changing the data in units of line or pixel, which is more simple than encryption. The encryption key memory 12 stores the scrambling rule as a secret key.

It is preferable that the fingerprint sensor 11, the encryption key memory 12 and the encryption section 13 of the fingerprint input device 1 are inseparably implemented in a single piece so as to protect against tampering, changing or tapping of internal signals flowing between them by an unauthorized person. For that purpose, it is effective that the encryption key memory 12 and the encryption section 13 are implemented by semiconductor process on the semiconductor chip mounted with the fingerprint sensor 11 as a monolithic semiconductor chip. In the case where a CMOS imager chip is used as the fingerprint sensor 11, for example, an encryption key memory and an encryption calculator are also implemented on the same CMOS imager chip. Alternatively, in the case where the fingerprint sensor 11 is a semiconductor sensor of electrostatic fingerprint sensing type, an encryption key memory and an encryption calculator are also implemented on the same semiconductor sensor.

The fingerprint verification device 2 includes a decryption section 21, a fingerprint feature extractor 22, a fingerprint feature comparator 23, an encryption information memory 24, a decision section 25, and a per-user fingerprint data table 26.

The decryption section 21 performs decryption of encrypted data received from the fingerprint input device 1 using a unique encryption key for the fingerprint input device 1 stored in an encryption information memory 24.

The encryption information memory 24 stores a pair of a unique encryption key and a corresponding device identifier (ID) for each fingerprint input device. Therefore, the decryption section 21 can input from the encryption information memory 24 the encryption key corresponding to the fingerprint input device 1 connected to the fingerprint verification device 2. The fingerprint verification device 2 can identify the fingerprint input device 1 connected thereto, for example, by exchanging type and identification information with the fingerprint input device 1 when starting the local connection. In other words, the fingerprint verification device 2 has different physical or virtual ports connected to a plurality of fingerprint input devices.

The decryption section 21 performs decryption according to the same encryption scheme as that of the encryption section 13 at the fingerprint input device 1. Therefore, as describe later, the validity of the source device and data received through the local connection can be determined depending on whether the decrypted data is semantically and syntactically correct.

Assuming that the encryption section 13 uses the common key encryption system, the decryption section 21 performs decryption using the same encryption key as that used in the encryption section 13. When the decryption is successfully performed, it is determined that the source device and the received data are valid.

Assuming that the encryption section 13 uses the public key (asymmetric) encryption system, the decryption section 21 performs decryption using a public encryption key corresponding to the secret key stored in the encryption key memory 12. When the decryption is successfully performed, it is determined that the source device and the received data are valid.

In the case where the scrambling of digital fingerprint image data is performed by shifting or changing data in units of line or pixel according to the scrambling rule as a secret key stored in the encryption key memory 12, the decryption section 21 performs the descrambling using the same scrambling rule. When the decryption is successfully performed, it is determined that the source device and the received data are valid.

The fingerprint feature extractor 22 calculates the feature of the decrypted fingerprint data output from the decryption section 21 and outputs the fingerprint feature to the fingerprint feature comparator 23. The fingerprint feature comparator 23 compares the fingerprint feature against finger features previously stored for comparison per user in the per-user fingerprint data table 26. The comparison result is output to the decision section 25.

As for the fingerprint sensor 11, the fingerprint feature extractor 22, and the fingerprint feature comparator 23, their examples are described in the Japanese Patent Application Unexamined Publication No. 4-33065 and the Japanese Patent Application Examined Publication No. 63-13226. More specifically, a fingerprint verification system according to the Japanese Patent Application Unexamined Publication No. 4-33065 allows easy-to-use and reliable identification of fingerprint by comparing input fingerprint data against one or more stored fingerprint patterns. A fingerprint verification system according to the Japanese Patent Application Examined Publication No. 63-13226 allows stable and reliable identification of fingerprint by checking the relation between feature points of fingerprint pattern and the nearest point in the vicinity of a plurality of fan-shaped areas obtained by dividing the local coordinates uniquely defined by the feature points.

The decision section 25 determines the validity of the user based on the correctness of the data received from the fingerprint input device 1 and the fingerprint comparison result of the fingerprint feature comparator 23.

As described before, the decryption section 21 searches the encryption information memory 24 for a secret key uniquely corresponding to the fingerprint input device 1 and performs decryption using the secret key. When encrypted data has been received from a true fingerprint input device, the decryption section 21 produces correct fingerprint data. Therefore, the decision section 25 can determine the validity of a fingerprint input device depending on whether the form of decrypted data matches that of the digital fingerprint image data output from the fingerprint sensor 11. If they match, it is determined that the encrypted data is received from an authorized fingerprint input device and, if not, it is determined that the encrypted data is received from an unauthorized fingerprint input device, which means that the decrypted data may be tampered by an unauthorized person.

In addition, the fingerprint feature comparator 23 compares the received fingerprint feature against fingerprint features previously stored for comparison per user in the per-user fingerprint data table 26 to determine whether the user inputting the fingerprint data is an authorized user. If the received fingerprint feature matches one of the previously stored fingerprint feature data, it is determined that the user is an authorized person. If no match is found, it is determined that the user is an unauthorized person.

In this manner, the decision section 25 receives the decrypted fingerprint data from the decryption section 21 and the fingerprint feature comparison result from the fingerprint feature comparator 23 and finally determines whether an authorized user operates an authorized fingerprint input device to log in.

### SECOND EMBODIMENT

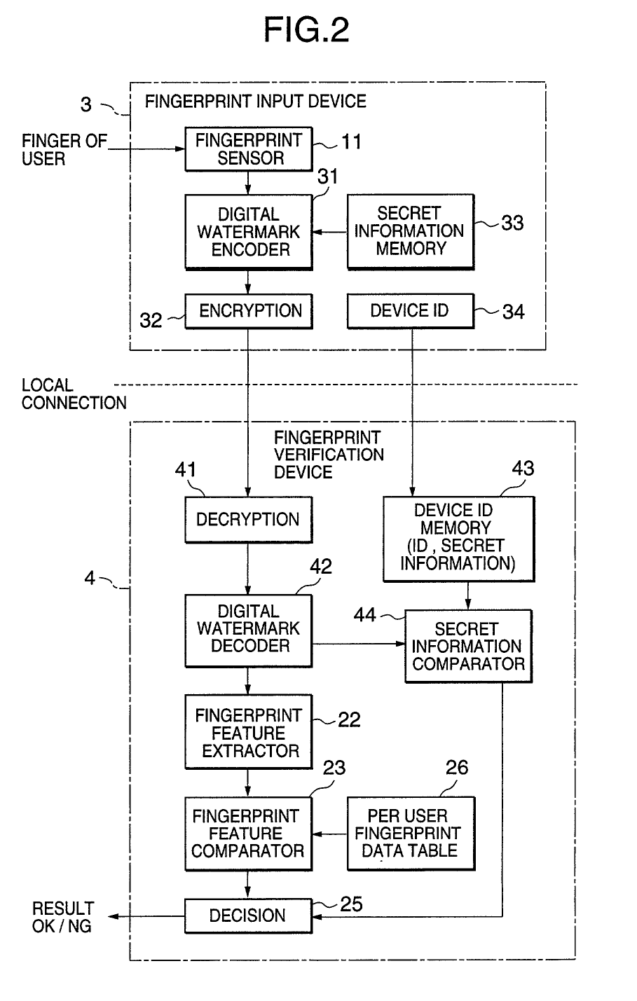

Referring to FIG. 2, a biometric identification system according to the second embodiment includes a fingerprint input device 3 and a fingerprint verification device 4, which are connected by a local connection such as a cable. A plurality of fingerprint input devices may be connected to the fingerprint verification device 4. Here, the fingerprint verification device 4 is implemented via software in a personal computer. In FIG. 2, circuit blocks similar to those previously described with reference to FIG. 1 are denoted by the same reference numerals.

The fingerprint input device 3 is provided with a fingerprint sensor 11 that scans the fingerprint of a user's finger placed on a scan window to output digital fingerprint image data to an digital watermark encoder 31. The digital watermark encoder 31 embeds secret information stored in a secret information memory 33 as a digital watermark in the digital fingerprint image data. The secret information is unique secret information that identifies the fingerprint input device 3 and is not known by ordinary users. For example, the secret information is a bit string such as a password.

A digital watermarking technique provides the following characteristics: 1) a digital watermark can be invisibly or visibly embedded in data; 2) an embedded watermark can be extracted by the user embedding the watermark using a secret key as in the case of encryption; 3) an embedded watermark is left and can be extracted after the data embedded with the watermark has been processed; and 4) it is difficult for an authorized person to extract the embedded watermark from the data while keeping the utility value thereof. Such a digital watermarking technique allows digital watermark data to be invisibly embedded in digital fingerprint image data without decreasing in the quality of the image, resulting in improved security. Further, extracting, deleting, or changing the embedded watermark cannot be made without considerably decreasing in the quality of digital fingerprint image. A digital watermarking technique of embedding a visible watermark in an original image is described in Japanese Patent Application Unexamined Publication No. 8-241403. A digital watermarking technique of inserting watermark data into MPEG data is disclosed in Japanese Patent Application Unexamined Publication No. 10-224793.

In this way, the digital watermark encoder 31 embeds the secret information stored in the secret information memory 33 as a digital watermark in the digital fingerprint image data and outputs the watermarked digital fingerprint image data to an encryption section 32. Since the fingerprint image can be visibly detected as it is from the watermarked digital fingerprint image data, encryption of the watermarked digital fingerprint image data is made so as to conceal the fingerprint image. The encrypted data is transmitted to the fingerprint verification device 4 through the local connection. A common key system such as DES (Data Encryption Standard) system may be used. Aside from the encrypted data, the fingerprint input device 3 transmits the device ID 34 identifying the fingerprint input device 3 itself to the fingerprint verification device 4.

It is preferable that the fingerprint sensor 11, the secret information memory 33 and the digital watermark encoder 31 of the fingerprint input device 3 are inseparably implemented in a single piece so as to protect against tampering, changing or tapping of internal signals flowing between them by an unauthorized person, which is described in the first embodiment.

The fingerprint verification device 4 includes a decryption section 41, a digital watermark decoder 42, a device ID memory 43, a secret information comparator 44, a fingerprint feature extractor 22, a fingerprint feature comparator 23, a decision section 25, and a per-user fingerprint data table 26.

The decryption section 41 performs decryption of encrypted data received from the fingerprint input device 3 to reproduce watermarked fingerprint data. The digital watermark decoder 42 decodes the watermarked fingerprint data according to the same watermarking scheme as the digital watermark encoder 31 to separate watermark data and digital fingerprint image data.

The device ID memory 43 stores a pair of a device identifier (ID) and secret information for each fingerprint input device. The secret information stored in the device ID memory 43 is the same as the secret information stored in the secret information memory 33 in the fingerprint input device 3.

The device ID memory 43 is searched for the device ID 34 received from the fingerprint input device 3 to output corresponding secret information to the secret information comparator 44. The secret information comparator 44 compares the secret information received from the device ID memory 43 with the watermark data separated by the digital watermark decoder 42. If the fingerprint input device 3 is an authorized machine, they should match because the watermark data is the secret information stored in the secret information memory 33 of the fingerprint input device 3. If they do not match, it is determined that the source device transmitting the encrypted data is unauthorized.

The fingerprint feature extractor 22 calculates the feature of the decrypted fingerprint image data output from the digital watermark decoder 42 and outputs the fingerprint feature to the fingerprint feature comparator 23. The fingerprint feature comparator 23 compares the fingerprint feature against finger features previously stored for comparison per user in the per-user fingerprint data table 26. The comparison result is output to the decision section 25.

The decision section 25 determines the validity of the user based on the secret information comparison result of the secret information comparator 44 and the fingerprint comparison result of the fingerprint feature comparator 23.

As described above, when encrypted data has been received from an authorized fingerprint input device, the secret information comparator 44 notifies the decision section 25 of secret information matching. Therefore, the decision section 25 can determine the validity of a fingerprint input device depending on whether the secret information matches the watermark data. If they match, it is determined that the encrypted data is received from an authorized fingerprint input device and, if not, it is determined that the encrypted data is received from an unauthorized fingerprint input device, which means that the decrypted data may be tampered by an unauthorized person.

In addition, the fingerprint feature comparator 23 compares the received fingerprint feature against fingerprint features previously stored for comparison per user in the per-user fingerprint data table 26 to determine whether the user inputting the fingerprint data is an authorized user. If the received fingerprint feature matches one of the previously stored fingerprint feature data, it is determined that the user is an authorized person. If no match is found, it is determined that the user is an unauthorized person.

In this manner, the decision section 25 receives the secret information comparison result from the secret information comparator 44 and the fingerprint feature comparison result from the fingerprint feature comparator 23 and finally determines whether an authorized user operates an authorized fingerprint input device to log in.

### THIRD EMBODIMENT

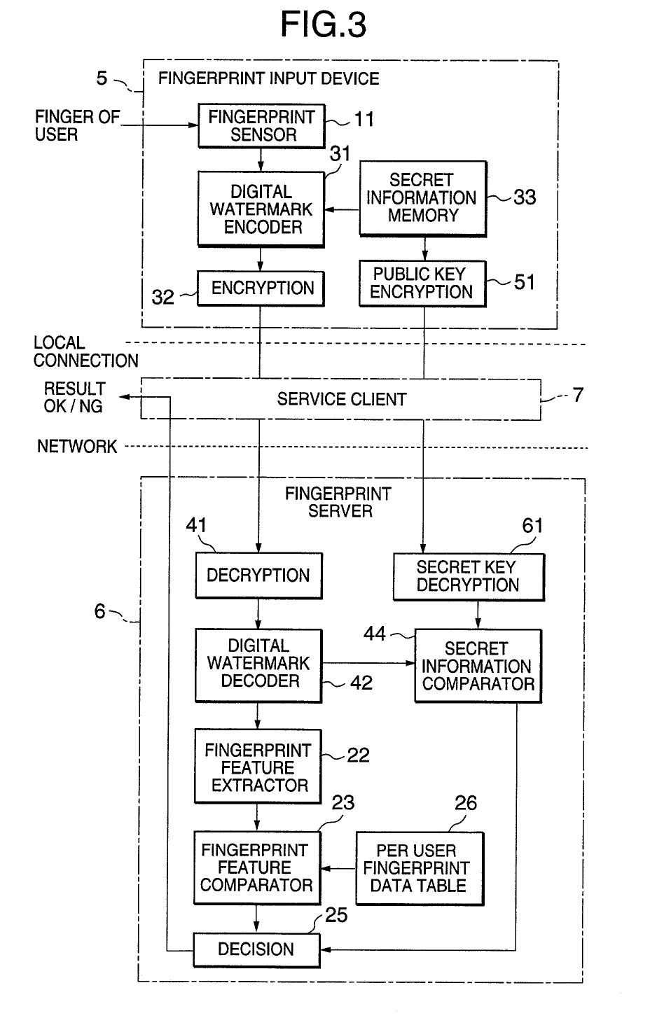

Referring to FIG. 3, a biometric identification system according to the third embodiment includes a fingerprint input device 5, a fingerprint server 6, and a service client 7. In FIG. 3, circuit blocks similar to those previously described with reference to FIG. 2 are denoted by the same reference numerals.

The fingerprint input device 5 is connected to the service client 7 by a local connection such as a cable. The service client 7 is connected to the fingerprint server 6 via a network. The service client 7 may be a user's personal computer on an office desk or in home, or a public POS (Point of sales) terminal installed in a store. The service client 7 serves as a provider of information services or electronic commerce. However, as for authentication, the service client 7 serves as a transparent intermediary that passes through communications between the fingerprint input device 6 and the fingerprint input device 5 without changing the communication contents.

The fingerprint input device 5 connected to the service client 7 has the essentially same circuit configuration and operation as in the case of the second embodiment. The watermarked fingerprint image data is transmitted to the fingerprint server 6 through a channel via the service client 7. In the third embodiment, however, the fingerprint input device 5 is provided with a public key encryption section 51 that encrypts the secret information stored in the secret information memory 33 using a public key of RSA corresponding to the fingerprint server 6. The encrypted secret information is then transmitted to the fingerprint server 6 through another channel via the service client 7.

The fingerprint server 6 connected to the service client 7 through the network has the essentially same circuit configuration and operation as in the case of the second embodiment. In the third embodiment, however, the fingerprint server 6 is provided with a secret key decryption section 61 that decrypts the received data using a secret key of its own corresponding to the public key to produce the secret information. The received secret information is output to the secret information comparator 44.

More specifically, the decryption section 41 performs decryption of encrypted data received from the fingerprint input device 5 to reproduce watermarked fingerprint data. The digital watermark decoder 42 decodes the watermarked fingerprint data according to the same watermarking scheme as the digital watermark encoder 31 to separate watermark data and digital fingerprint image data.

The device ID memory 43 stores a pair of a device identifier (ID) and secret information for each fingerprint input device. The secret information stored in the device ID memory 43 is the same as the secret information stored in the secret information memory 33 in the fingerprint input device 3.

The secret information comparator 44 compares the secret information received from the secret key decryption section 61 with the watermark data separated by the digital watermark decoder 42. If the fingerprint input device 5 is an authorized machine, they should match because the watermark data is the secret information stored in the secret information memory 33 of the fingerprint input device 5. If they do not match, it is determined that the source device transmitting the encrypted data is unauthorized.

The fingerprint feature extractor 22 calculates the feature of the decrypted fingerprint image data output from the digital watermark decoder 42 and outputs the fingerprint feature to the fingerprint feature comparator 23. The fingerprint feature comparator 23 compares the fingerprint feature against finger features previously stored for comparison per user in the per-user fingerprint data table 26. The comparison result is output to the decision section 25.

The decision section 25 determines the validity of the user based on the secret information comparison result of the secret information comparator 44 and the fingerprint comparison result of the fingerprint feature comparator 23.

As described above, when encrypted data has been received from an authorized fingerprint input device, the secret information comparator 44 notifies the decision section 25 of secret information matching. Therefore, the decision section 25 can determine the validity of a fingerprint input device depending on whether the secret information matches the watermark data. If they match, it is determined that the encrypted data is received from an authorized fingerprint input device and, if not, it is determined that the encrypted data is received from an unauthorized fingerprint input device, which means that the decrypted data may be tampered by an unauthorized person.

In addition, the fingerprint feature comparator 23 compares the received fingerprint feature against fingerprint features previously stored for comparison per user in the per-user fingerprint data table 26 to determine whether the user inputting the fingerprint data is an authorized user. If the received fingerprint feature matches one of the previously stored fingerprint feature data, it is determined that the user is an authorized person. If no match is found, it is determined that the user is an unauthorized person.

In this manner, the decision section 25 receives the secret information comparison result from the secret information comparator 44 and the fingerprint feature comparison result from the fingerprint feature comparator 23 and finally determines whether an authorized user operates an authorized fingerprint input device. The authentication result is transmitted to the service client 7 and only when it is determined that an authorized user operates an authorized fingerprint input device, the service client 7 provides the user with the user-demanded service.

As described before, the encrypted fingerprint image data and the encrypted secret information are transmitted from the fingerprint input device 5 to the fingerprint server 6 through separate channels. It is possible to employ a structure such that the fingerprint server 6 previously stores a pair of secret information and corresponding device ID for each of all fingerprint input devices connected in the network. However, in the case of an increased number of fingerprint input devices, it is preferable that the separate channels are used to transmit the encrypted fingerprint image data and the encrypted secret information so as to easily deal with change or replacement of fingerprint input devices.

In the above-described embodiments, fingerprint data is used as biometric data. Other physical characteristics such as hand geometry, retinal scans, facial images, iris, handprint, handwriting, and voiceprint may be used as biometric data. For example, voice data captured by a microphone may be encrypted or watermarked using the secret information corresponding uniquely to a voiceprint input device connected inseparably to the microphone. Such encrypted voice data can be used similarly in the above-described embodiments.

As described above, using decrypted or watermarked data to communicate between a biometric data input device and a biometric verification device can effectively avoid causing the biometric data input device to be changed or replaced, resulting in enhanced security and reliable authentication. Accordingly, even if an unauthorized person steals the biometric data of an authorized person and changes the biometric data input device to another one or the cable to anther cable to transmit the stolen data to the biometric verification device, the unauthorized person cannot log in to the system because the unique secret information of the authorized biometric data input device is not used. Therefore, the security attach by the unauthorized person can be effectively avoided. In the case where a plurality of biometric data input devices and the biometric verifier are separately located and connected by a network, the possibility of the security attach can be also dramatically reduced.

1. A system comprising:
a biometric data input device; and
a biometric verifier connected to the biometric data input device,
wherein the biometric data input device comprises:
a biometric data sensor for inputting as biometric data a physical characteristic of an individual to produce digital biometric data; and
an encoder for encoding the digital biometric data using secret information to transmit encoded data to the biometric verifier, and
the biometric verifier comprises:
a decoder for decoding the encoded data using the secret information to reproduce digital biometric data;
a verifier for verifying identity of the individual based on the digital biometric data.

2. The system according to claim 1, wherein the secret information is a unique key identifying the biometric data input device.

3. The system according to claim 2, wherein the verifier comprises:
a feature extractor for extracting a feature of the digital biometric data decoded by the decoder;
a first determiner for determining whether the feature of the digital biometric data is a registered biometric feature of an authorized user, by comparing the feature of the digital biometric data against previously registered biometric features;
a second determiner for determining whether the biometric data input device is an authorized device, based on the secret information; and
a third determiner for determining that the individual is an authorized user when the feature of the digital biometric data is a registered biometric feature of an authorized user and the biometric data input device is an authorized device.

4. A system comprising:
at least one biometric data input device; and
a biometric verifier connected to the at least one biometric data input device,
wherein each of the at least one biometric data input device comprises:
a biometric data sensor for inputting as biometric data a physical characteristic of an individual to produce digital biometric data; and
an encryptor for encrypting the digital biometric data using an encryption key to transmit encrypted data to the biometric verifier, wherein the encryption key identifies the biometric data input device, and
the biometric verifier comprises:
a table storing an encryption key corresponding to each of said at least one biometric data input device;
a decryptor for decrypting the encrypted data using the encryption key corresponding to the biometric data input device to reproduce digital biometric data;
a comparator for comparing a feature of the digital biometric data against previously registered biometric features to produce a comparison result; and
a determiner for determining whether the individual is an authorized person, based on the comparison result and correctness of the digital biometric data decrypted by the decryptor.

5. The system according to claim 4, wherein the determiner determines the correctness of the digital biometric data decrypted by the decryptor depending on whether a type of the digital biometric data decrypted by the decryptor matches that of the digital biometric data outputted by the biometric data input device.

6. The system according to claim 4, wherein a fingerprint is used as the physical characteristic.

7. A system comprising:
at least one biometric data input device; and
a biometric verifier connected to the at least one biometric data input device,
wherein each of the at least one biometric data input device comprises:
a biometric data sensor for inputting as biometric data a physical characteristic of an individual to produce digital biometric data;
a watermark encoder for embedding secret information as a watermark in the digital biometric data to produce watermarked biometric data;
an encryptor for encrypting the watermarked biometric data to produce encrypted data; and
a transmitter for transmitting the encrypted data and a device identification identifying the biometric data input device to the biometric verifier, and
the biometric verifier comprises:
a table storing secret information corresponding to a device identification for each of said at least one biometric data input device;
a decryptor for decrypting the encrypted data to produce watermarked digital biometric data;
a watermark decoder for separating digital biometric data and watermark data from the watermarked digital biometric data decrypted by the decryptor;
a first comparator for comparing a feature of the digital biometric data against previously registered biometric features to produce a feature comparison result;
a second comparator for comparing the watermark data separated by the watermark decoder with secret information corresponding to the device identification identifying the biometric data input device to produce a secret information comparison result; and
a determiner for determining whether the individual is an authorized person, based on the feature comparison result and the secret information comparison result.

8. The system according to claim 7, wherein a fingerprint is used as the physical characteristic.

9. A system comprising:
at least one biometric data input device; and
a biometric verifier connected to the at least one biometric data input device,
wherein each of the at least one biometric data input device comprises:
a biometric data sensor for inputting as biometric data a physical characteristic of an individual to produce digital biometric data;
a watermark encoder for embedding secret information as a watermark in the digital biometric data to produce watermarked biometric data;
a first encryptor for encrypting the watermarked biometric data to produce encrypted biometric data;
a second encryptor for encrypting the secret information using a public key of asymmetric encryption scheme to produce encrypted secret information; and
a transmitter for transmitting the encrypted biometric data and the encrypted secret information, and
the biometric verifier comprises:
a first decryptor for decrypting the encrypted biometric data to produce watermarked digital biometric data;
a second decryptor for decrypting the encrypted secret information to produce received secret information;
a watermark decoder for separating digital biometric data and watermark data from the watermarked digital biometric data decrypted by the decryptor;
a first comparator for comparing a feature of the digital biometric data against previously registered biometric features to produce a feature comparison result;
a second comparator for comparing the watermark data separated by the watermark decoder with the received secret information to produce a secret information comparison result; and
a determiner for determining whether the individual is an authorized person, based on the feature comparison result and the secret information comparison result.

10. The system according to claim 9, wherein a fingerprint is used as the physical characteristic.

11. The system according to claim 9, wherein the biometric verifier is connected to the at least one biometric data input device via a network.

12. The system according to claim 11, wherein the encrypted biometric data and the encrypted secret information are transmitted to the biometric verifier through different channels.

13. A biometric data input device connected to a biometric verifier, comprising:
a biometric data sensor for inputting as biometric data a physical characteristic of an individual to produce digital biometric data;
a memory storing an encryption key identifying the biometric data input device; and
an encryptor for encrypting the digital biometric data using the encryption key to transmit encrypted data to the biometric verifier.

14. The biometric data input device according to claim 13, wherein the biometric data sensor, the memory, and the encryptor are inseparably implemented in one piece.

15. The biometric data input device according to claim 13, wherein a fingerprint is used as the physical characteristic.

16. A biometric data input device connected to a biometric verifier, comprising:
a biometric data sensor for inputting as biometric data a physical characteristic of an individual to produce digital biometric data;
a memory storing secret information corresponding to the biometric data input device;
a watermark encoder for embedding the secret information as a watermark in the digital biometric data to produce watermarked biometric data;
an encryptor for encrypting the watermarked biometric data to produce encrypted data; and
a transmitter for transmitting the encrypted data and a device identification identifying the biometric data input device to the biometric verifier.

17. The biometric data input device according to claim 16, wherein the biometric data sensor, the memory, and the encryptor are inseparably implemented in one piece.

18. The biometric data input device according to claim 16, wherein a fingerprint is used as the physical characteristic.

19. A biometric data input device connected to a biometric verifier, comprising:
a biometric data sensor for inputting as biometric data a physical characteristic of an individual to produce digital biometric data;
a watermark encoder for embedding secret information as a watermark in the digital biometric data to produce watermarked biometric data;
a first encryptor for encrypting the watermarked biometric data to produce encrypted biometric data;
a second encryptor for encrypting the secret information using a public key of asymmetric encryption scheme to produce encrypted secret information; and
a transmitter for transmitting the encrypted biometric data and the encrypted secret information.

20. The biometric data input device according to claim 19, wherein a fingerprint is used as the physical characteristic.

21. A biometric verifier connected to at least one biometric data input device, comprising:
a table storing an encryption key corresponding to each of said at least one biometric data input device;
a decryptor for decrypting encrypted data using the encryption key corresponding to a biometric data input device to reproduce digital biometric data, wherein the encrypted data is received from the biometric data input device;
a comparator for comparing a feature of the digital biometric data against previously registered biometric features to produce a comparison result; and
a determiner for determining whether the individual is an authorized person, based on the comparison result and correctness of the digital biometric data decrypted by the decryptor.

22. A biometric verifier connected to at least one biometric data input device, comprising:
a table storing secret information corresponding to a device identification for each of said at least one biometric data input device;
a decryptor for decrypting encrypted data to produce watermarked digital biometric data, wherein the encrypted data is received from a biometric data input device;
a watermark decoder for separating digital biometric data and watermark data from the watermarked digital biometric data decrypted by the decryptor;
a first comparator for comparing a feature of the digital biometric data against previously registered biometric features to produce a feature comparison result;
a second comparator for comparing the watermark data separated by the watermark decoder with secret information corresponding to the device identification identifying the biometric data input device to produce a secret information comparison result; and
a determiner for determining whether the individual is an authorized person, based on the feature comparison result and the secret information comparison result.

23. A biometric verifier connected to at least one biometric data input device, comprising:
a first decryptor for decrypting encrypted biometric data to produce watermarked digital biometric data, wherein the encrypted data is received from a biometric data input device;
a second decryptor for decrypting encrypted secret information to produce received secret information, wherein the encrypted secret information is received from the biometric data input device;
a watermark decoder for separating digital biometric data and watermark data from the watermarked digital biometric data decrypted by the decryptor;
a first comparator for comparing a feature of the digital biometric data against previously registered biometric features to produce a feature comparison result;
a second comparator for comparing the watermark data separated by the watermark decoder with the received secret information to produce a secret information comparison result; and
a determiner for determining whether the individual is an authorized person, based on the feature comparison result and the secret information comparison result.

24. In a system comprising: a biometric data input device; and a biometric verifier connected to the biometric data input device, a method for verifying identity of an individual, comprising the steps of:
at the biometric data input device,
a) inputting as biometric data a physical characteristic of an individual to produce digital biometric data; and
b) encoding the digital biometric data using secret information to transmit encoded data to the biometric verifier, and
at the biometric verifier,
c) decoding the encoded data using the secret information to reproduce digital biometric data;
d) verifying identity of the individual based on the digital biometric data.

25. The method according to claim 24, wherein the step (d) comprises the steps of:
extracting a feature of the digital biometric data decoded by the decoder;
determining whether the feature of the digital biometric data is a registered biometric feature of an authorized user, by comparing the feature of the digital biometric data against previously registered biometric features;
determining whether the biometric data input device is an authorized device, based on the secret information; and
determining that the individual is an authorized user when the feature of the digital biometric data is a registered biometric feature of an authorized user and the biometric data input device is an authorized device.

26. In a system comprising: a biometric data input device; and a biometric verifier connected to the biometric data input device, a method for verifying identity of an individual, comprising the steps of:
at the biometric data input device,
a) inputting as biometric data a physical characteristic of an individual to produce digital biometric data; and
b) encrypting the digital biometric data using an encryption key to transmit encrypted data to the biometric verifier, wherein the encryption key identifies the biometric data input device, and
at the biometric verifier,
c) storing an encryption key corresponding to each of said at least one biometric data input device;
d) decrypting the encrypted data using the encryption key corresponding to the biometric data input device to reproduce digital biometric data;
e) comparing a feature of the digital biometric data against previously registered biometric features to produce a comparison result; and
f) determining whether the individual is an authorized person, based on the comparison result and correctness of decrypted digital biometric data.

27. The method according to claim 26, wherein, in the step (f), the correctness of the decrypted digital biometric data is determined depending on whether a type of the decrypted digital biometric data matches that of the digital biometric data outputted by the biometric data input device.

28. In a system comprising: a biometric data input device; and a biometric verifier connected to the biometric data input device, a method for verifying identity of an individual, comprising the steps of:
at the biometric data input device,
inputting as biometric data a physical characteristic of an individual to produce digital biometric data;
embedding secret information as a watermark in the digital biometric data to produce watermarked biometric data;
encrypting the watermarked biometric data to produce encrypted data; and
transmitting the encrypted data and a device identification identifying the biometric data input device to the biometric verifier;
at the biometric verifier,
storing secret information corresponding to a device identification for each of said at least one biometric data input device;
decrypting the encrypted data to produce watermarked digital biometric data;
separating digital biometric data and watermark data from decrypted watermarked digital biometric data;
comparing a feature of the digital biometric data against previously registered biometric features to produce a feature comparison result;
comparing the separated watermark data with secret information corresponding to the device identification identifying the biometric data input device to produce a secret information comparison result; and
determining whether the individual is an authorized person, based on the feature comparison result and the secret information comparison result.

29. In a system comprising: a biometric data input device; and a biometric verifier connected to the biometric data input device, a method for verifying identity of an individual, comprising the steps of:
at the biometric data input device,
inputting as biometric data a physical characteristic of an individual to produce digital biometric data;
embedding secret information as a watermark in the digital biometric data to produce watermarked biometric data;
encrypting the watermarked biometric data to produce encrypted biometric data;
encrypting the secret information using a public key of asymmetric encryption scheme to produce encrypted secret information; and
transmitting the encrypted biometric data and the encrypted secret information, and
at the biometric verifier,
decrypting the encrypted biometric data to produce watermarked digital biometric data;
decrypting the encrypted secret information to produce received secret information;
separating digital biometric data and watermark data from the decrypted watermarked digital biometric data;
comparing a feature of the digital biometric data against previously registered biometric features to produce a feature comparison result;
comparing the separated watermark data with the received secret information to produce a secret information comparison result; and
determining whether the individual is an authorized person, based on the feature comparison result and the secret information comparison result.
